(19) United States
(12) Patent Application Publication
(10) Pub. No.: US 2004/0100489 A1
(43) Pub. Date: May 27, 2004

(54) Automatic 3-D web content generation

(75) Inventors: Alexander L. Berestov, San Jose, CA (US); David D. Deer, Mountain View, CA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/303,972

(22) Filed: Nov. 26, 2002

(51) Int. Cl. G09G 5/00

(52) U.S. Cl. 345/738; 345/850; 345/760

(57) ABSTRACT

Automatically generating a three dimensional web page from a two dimensional web page for display in a web browser by the web browser receiving two dimensional (HTML) content for the two dimensional web page, parsing the two dimensional content to separate (HTML) objects contained in the two dimensional content and to identify (utilizing HTML tags) an object type (e.g. text, buttons, frames, images, animation and video) for the objects contained in the two dimensional content, processing the objects differently (e.g. utilizing different algorithms), based on the object type identified in the parsing step, to generate three dimensional (HTML) content for the objects, and generating the three dimensional (HTML) web page utilizing the three dimensional content for the objects obtained in the processing step. Color channel separation may be performed to separate different color channels, such as red, blue and green. Additionally, parallax generation may be used to prescribe a different shift between channels to different objects so as to create depth. Further, color adjustment may be performed to replace colors with enhanced colors so as to improve depth perception, thereby adjusting colors that are too red or too blue, and removing visible doubling of images (“ghost images”).

### BACKGROUND OF THE INVENTION

1. Field Of The Invention

The present invention concerns automatic generation of three dimensional web content in a browser on a workstation. More particularly, the present invention automatically generates a three dimensional web page from a two dimensional web page in a web browser by parsing two dimensional content of the two dimensional web page to separate and identify main objects contained in the two dimensional content, processing each object differently based on the object type to generate three dimensional content for each object, and generating a three dimensional web page from the three dimensional content.

2. Description Of The Related Art

Three dimensional (3-D) web-sites on the Internet have been known to exist. Conventional 3-D web-sites utilize a variety of techniques such as stereo pairs, anaglyphs, shuttering and holographs, to provide 3-D web content that can be downloaded and displayed in a web browser's window. According to these conventional techniques, the 3-D content is generated on the server side utilizing any of the foregoing techniques and the 3-D content is then downloaded to the browser for display. A user can view the 3-D images using any of a variety of known techniques depending on the 3-D content. For example, the user can view the images utilizing red/cyan glasses, shutter glasses, or stereo defocusing. While the 3-D content is generally created by an owner of software on the server side and is provided to the user upon request, it has also been known for users to submit their own 2-D content to a service provider who will generate 3-D content for the user that the user can then download for viewing. While the foregoing techniques have provided the ability for users to view 3-D content on a web browser, the content that is available for users to view is limited to that which is generated by the server side owners. Thus, with the foregoing server side techniques, users are limited in the content which can be viewed in 3-D and users cannot simply generate 3-D content at will for 2-D content of their choosing.

A technique is known however, for generating 3-D content on a workstation from 2-D content. With this technique, an original 2-D image is analyzed to generate a corresponding depth image based on depth gradation parameters input by the user. The original image and the depth image are utilized to generate two separate images, one for the left eye and one for the right eye. However, the foregoing technique requires fairly extensive knowledge by the user of depth gradation technology in order for the 3-D image to be rendered. That is, in order to generate the depth image, the user has to input depth gradation values for each region in the original image in order for the process to be able to generate the depth image, and consequently, the two separate images for each eye. As a result, only sophisticated users that have the required degree of knowledge are able to generate appropriate 3-D images for viewing. Thus, what is needed is a technique for generating 3-D content on the client side that is more user friendly than the foregoing conventional techniques and the present invention provides such a solution.

### SUMMARY OF THE INVENTION

The present invention addresses the foregoing by providing an easy way for users to generate three dimensional web pages in their browser. According to the invention, a web browser receives two dimensional content, such as a standard HTML web page. The content of the two dimensional web page is parsed by the web browser to separate objects contained in the two dimensional content and to identify an object type for each object. For instance, the objects (generally, the main objects) contained in the HTML web page may be text, buttons, frames, images, animations and video and may be identified by tags, such as HTML tags. Each object is then processed differently based on the object type. For example, each object may be subjected to a different algorithm specific to the object type so as to generate three dimensional content for each object. The three dimensional content for each object is then brought together to generate a three dimensional HTML web page that can then be displayed by the browser and can be viewed by the user utilizing, for example, red/blue glasses.

As a result, the process can be easily invoked, either automatically as a default option in the browser or by a user simply clicking on an option in the web browser to create three dimensional content. Having clicked on the option to generate three dimensional content, the browser performs the necessary operations to generate the three dimensional images. Thus, virtually any two dimensional web page content that is received by the browser can be converted into three dimensional content. Accordingly, the user is not limited to only viewing three dimensional images for web pages generated at the server side, but can have virtually any web page generated into three dimensional content. Moreover, the user does not need to have any knowledge regarding depth gradation values in order to have the three dimensional content generated. Rather, the user simply clicks on an option to generate the three dimensional content in the browser, whereby the web browser automatically performs the necessary processes.

Thus, in one aspect, the invention automatically generates a three dimensional web page from a two dimensional web page for display in a web browser by the web browser receiving two dimensional content for the two dimensional web page, parsing the two dimensional content to separate objects contained in the two dimensional content and to identify an object type for the objects contained in the two dimensional content, processing the objects differently, based on the object type identified in the parsing step, to generate three dimensional content for the objects, and generating the three dimensional web page utilizing the three dimensional content for each object obtained in the processing step.

The invention may be employed as a plug-in module for a web browser, and may be implemented in any language including HTML, XML and JAVA. Accordingly, the objects contained in the two dimensional web page may be identified by HTML tags, XML tags or JAVA tags. Additionally; the objects may be, for example, main objects such as text, buttons, frames, images, animations and video. Having identified each object, they may be processed differently by applying a different algorithm for each object type. Thus, enhanced three dimensional content may be obtained by the specific algorithm for each object.

In a related aspect, the invention may further perform color channel separation to separate different color channels, such as red, blue and green. This step provides a way to generate anaglyph web pages in which the red color and the blue and green colors are shifted relative to one another. Then, parallax generation is used to prescribe a different shift between channels to different objects so as to create depth. Finally, color adjustment may be performed to replace colors with enhanced colors so as to improve depth perception. This latter process provides a way to adjust colors that are too red or too blue, and to remove visible doubling of images (“ghost images”).

While the foregoing applies primarily to anaglyph web pages, the process could also be applied to other techniques for generating three dimensional web pages. For instance, two HTML pages could be generated to be displayed as a stereo pair. In such a case, the foregoing process of channel separation and color adjustment may be omitted.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 depicts an example of a computing environment in which the invention may be employed.

FIG. 2 depicts an example of an internal architecture of a computer workstation in which the invention may be employed.

FIG. 3 depicts an example of an internal architecture of a web server.

FIG. 4 depicts an example of a two dimensional web page displayed in a web browser.

FIG. 5 depicts an example of a three dimensional web page displayed in a web browser.

FIG. 6 is a block diagram depicting a process of generating three dimensional web page content in accordance with the invention.

FIG. 7 is a flowchart of process steps for generating a three dimensional web page according to the invention.

FIG. 8 depicts HTML source code for the 2-D web page displayed in FIG. 4.

FIG. 9 depicts HTML source code for the 3-D web page displayed in FIG. 5.

### DETAILED DESCRIPTION OF THE PREFERRED EMBODIMENTS

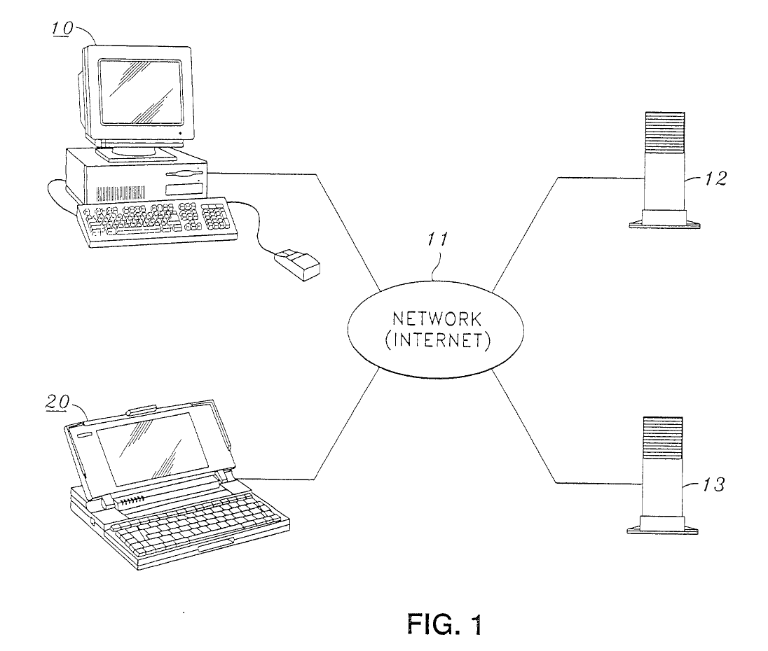

FIG. 1 depicts an example of a computing environment in which the invention may be employed. Briefly, the invention is directed to the generation and display of three dimensional web pages on, preferably, a personal computer. Thus, as seen in FIG. 1, the invention may be employed in an environment that includes personal computer 10 or laptop computer 20 that are connected to a network 11, which is preferably a world wide network such as the Internet. In this manner, computer workstation 10 or laptop 20 can communicate with any of various servers connected to the Internet so as to access various web-sites. For example, computer workstation 10 can communicate with any of servers 12 and 13 as seen in FIG. 1. Of course, servers 12 and 13 are not necessarily the only servers that may be connected to the Internet and numerous additional servers may also be included. Rather, servers 12 and 13 are merely representative examples and are depicted in FIG. 1 merely for illustrative purposes. Preferably, however, server 12 is owned and operated by an Internet Service Provider so as to provide computer workstation 10 with access to the Internet, while server 13 is preferably a server owned and operated by an Internet web site host provider to provide information to computer 10.

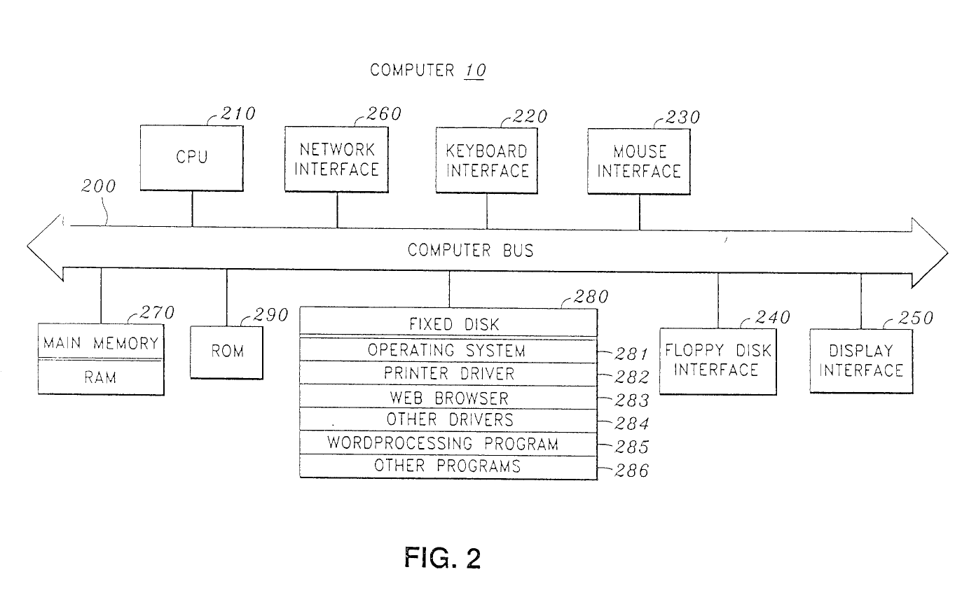

FIG. 2 is a block diagram showing an example of the internal architecture of a computer workstation, such as workstation 10. In FIG. 2, workstation 10 is seen to include central processing unit (CPU) 210 such as a programmable microprocessor which is interfaced to computer bus 200. Also coupled to computer bus 200 are keyboard interface 220 for interfacing to a keyboard, mouse interface 230 for interfacing to a mouse or other pointing device, floppy disk interface 240 for interfacing to a floppy disk, display interface 250 for interfacing to a monitor or other display, and network interface 260 for interfacing to a network, such as Internet 11. Interface 260 may be, for example, a 56K modem, a DSL modem, a cable modem, an Ethernet card that may or may not communicate with an external modem, etc.

Random access memory (RAM) 270 interfaces to computer bus 200 to provide CPU 210 with access to memory storage, thereby acting as the main run-time memory for CPU 210. In particular, when executing stored program instruction sequences, CPU 210 loads those instruction sequences from fixed disk 280 (or other memory media) into RAM 270 and executes those stored program instruction sequences out of RAM 270. It should also be noted that standard-disk swapping techniques available under windowing operating systems allow segments of memory to be swapped to and from RAM 270 and fixed disk 280. Read-only memory (ROM) 290 stores invariant instruction sequences, such as start-up instruction sequences for CPU 210 or basic input/output operation system (BIOS) sequences for the operation of peripheral devices (not shown) attached to workstation 10.

Fixed disk 280 is one example of a computer-readable medium that stores program instruction sequences executable by CPU 210. The program instructions may constitute windows operating system 281, printer driver 282, web browser 283, other drivers 284, word processing program 285, and other programs 286. Operating system 281 is preferably a windows operating system although other types of operating systems may be used with the present invention. Printer driver 282 is utilized to prepare image data for printing on at least one image forming device. Web browser application 283 is preferably a browser application such as Netscape® Navigator or Microsoft® Internet Explorer, although other web browser application may be utilized instead. However, the web browser should preferably support plug-ins such that, in a case where the present invention may be employed as a plug-in for a web browser, the invention may be installed and utilized with the web browser application. In addition, the web browser preferably supports various types of web page source code, including but not limited to HTML, Java Script, etc. Other drivers 284 include drivers for each of the remaining interfaces which are coupled to computer bus 200. Word processing program 285 is a typical word processor program for creating documents and images, such as Microsoft® Word, or Corel® WordPerfect documents. Other programs 286 contains other programs necessary to operate workstation 20 and to run desired applications.

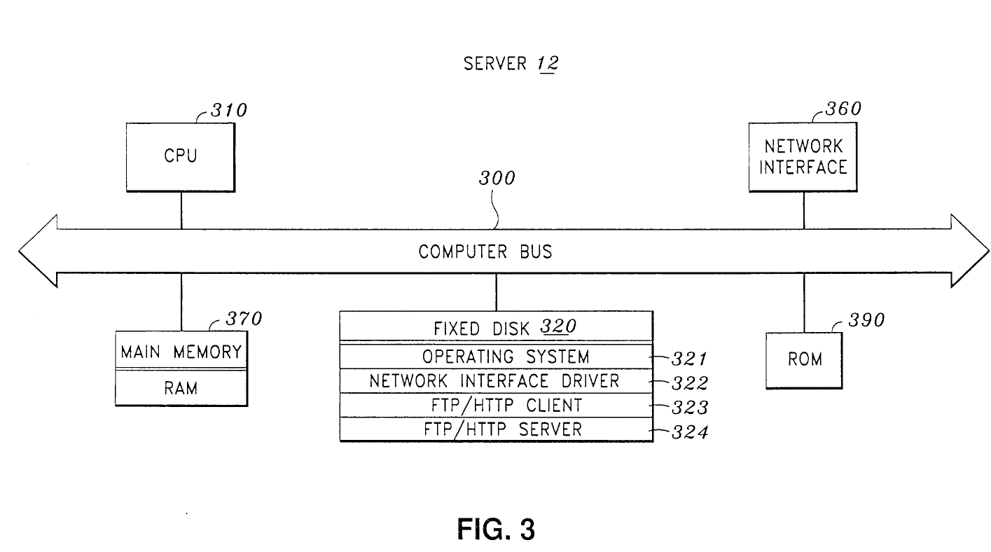

FIG. 3 depicts a block diagram showing an overview of the internal architecture of a server, such as servers 12 and 13. In this regard, the internal architecture of both servers may be similar. In FIG. 3, server 12 is seen to include a central processing unit (CPU) 310 such as a programmable microprocessor which is interfaced to computer bus 300. Also coupled to computer bus 300 is a network interface 360 for interfacing to a network, such as Internet 1. In addition, random access memory (RAM) 370, fixed disk 320, and read-only (ROM) 390 are also coupled to computer bus 300. RAM 370 interfaces to computer bus 300 to provide CPU 310 with access to memory storage, thereby acting as the main run-time memory for CPU 310. In particular, when executing stored program instruction sequences, CPU 310 loads those instruction sequences from fixed disk 320 (or other memory media) into RAM 370 and executes those stored program instruction sequences out of RAM 370. It should also be recognized that standard disk-swapping techniques allow segments of memory to be swapped to and from RAM 370 and fixed disk 320. ROM 390 stores invariant instruction sequences, such as start-up instruction sequences for CPU 310 or basic input/output operating system (BIOS) sequences for the operation of peripheral devices which may be attached to server 30 (not shown).

Fixed disk 320 is one example of a computer-readable medium that stores program instruction sequences executable by CPU 310. The program instruction sequences may include operating system 321 and network interface driver 322. Operating system 321 can be an operating system such as Windows NT 4.0 (or later versions thereof), UNIX, Novell® Netware or other such server operating systems. Network interface driver 322 is utilized to drive network interface 360 for interfacing server 12 to network (Internet) 1.

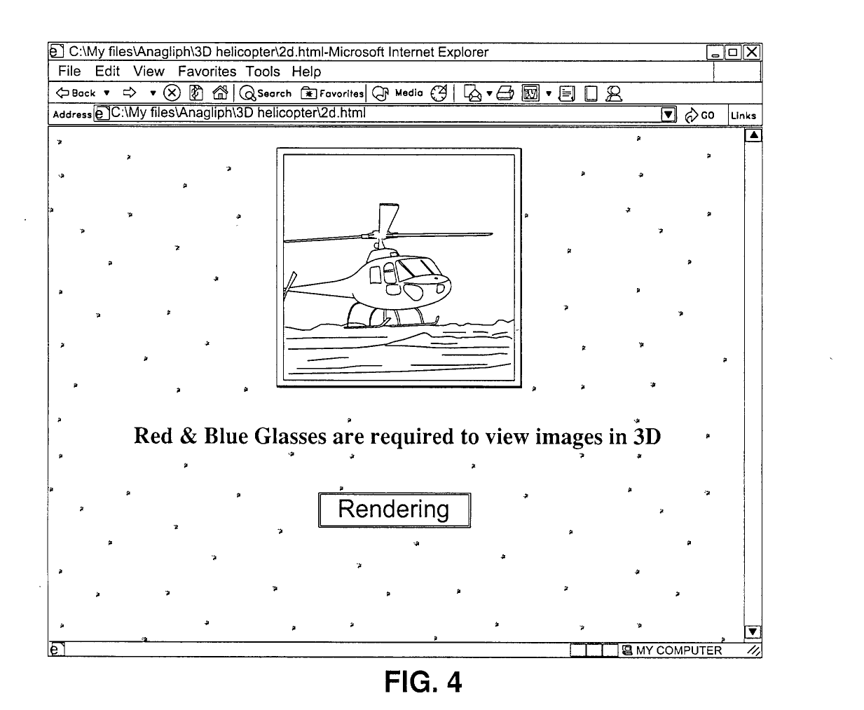

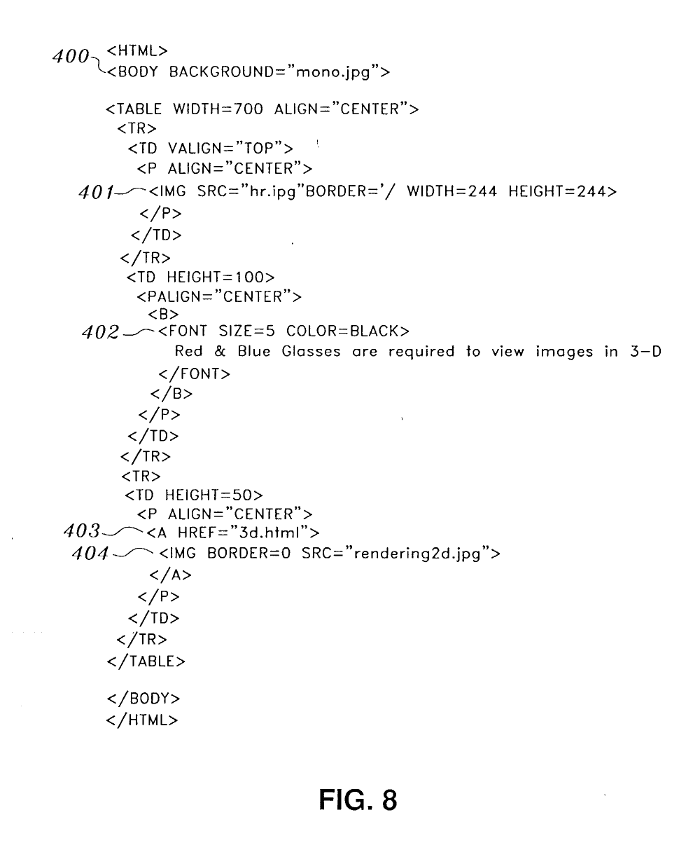

Server 12 also preferably includes FTP/HTTP client 323 to provide server 12 with the ability to retrieve and transmit data files via FTP and HTTP protocols over the network through network interface 360. In addition, FTP/HTTP server 324 can be accessed by an FTP/HTTP client in a workstation such as workstation 10. In this regard, FTP/HTTP server 324 is preferably a web server that can be accessed by web browser application 283 to retrieve and download web pages, which are preferably comprised of an HTML document. Of course, other, types of web based documents which include source code supported by the web browser can be utilized and the invention is not limited to HTML. However, for the sake of brevity, the invention will be described with regard to HTML. A user wanting to access a web site to have a web page downloaded enters a URL (Uniform Resource Locator), or other type of location information where a web page may be stored, in the web browser of workstation 10, whereby the web page (in the form of an HTML document) is received by workstation 10 for display in the web browser. Having received the HTML document for the web page, the web browser interprets HTML source code in the HTML document to display the web page in the browser. The process of accessing web pages over the Internet or an Intranet is well known in the art and any process to have a web page downloaded and displayed in the web browser can be used to practice the invention. Having downloaded or otherwise accessed a web page, the web page is processed and displayed by the web browser for the user to view. FIG. 4 depicts an example of a typical two dimensional web page that may be displayed in a web browser. FIG. 8 depicts the HTML source code for the two dimensional web page shown in FIG. 4.

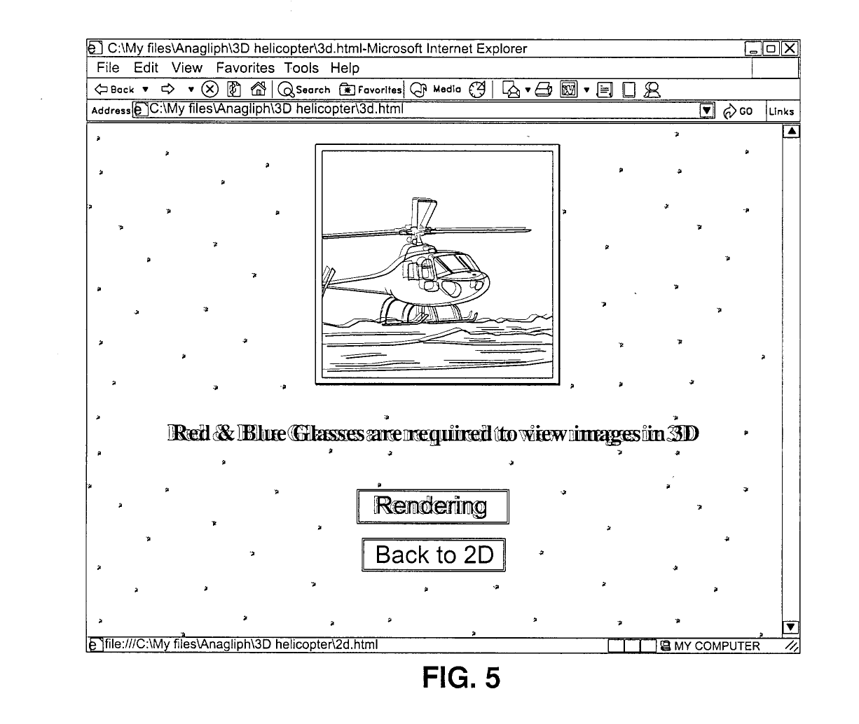

A description will now be made of generating a three dimensional web page according to the invention. The description will be made in the form of an example of generating an anaglyph three dimensional web page as shown in FIG. 5 from the two dimensional web page of FIG. 4. Of course, the invention is not limited to generating anaglyph images and the invention could be used to generate other types of three dimensional web pages, including stereo pages. The type of three dimensional web pages generated depends, of course, on the type of gear used to view the images. For example, shutter glasses would normally utilize stereo web pages (i.e., two separate web pages that are similar but created for viewing by either the right eye or the left eye), whereas, if the image is to be viewed with red/blue glasses, one anaglyph web page may be generated. However, for brevity, the invention will be described with regard to creation of an anaglyph web page.

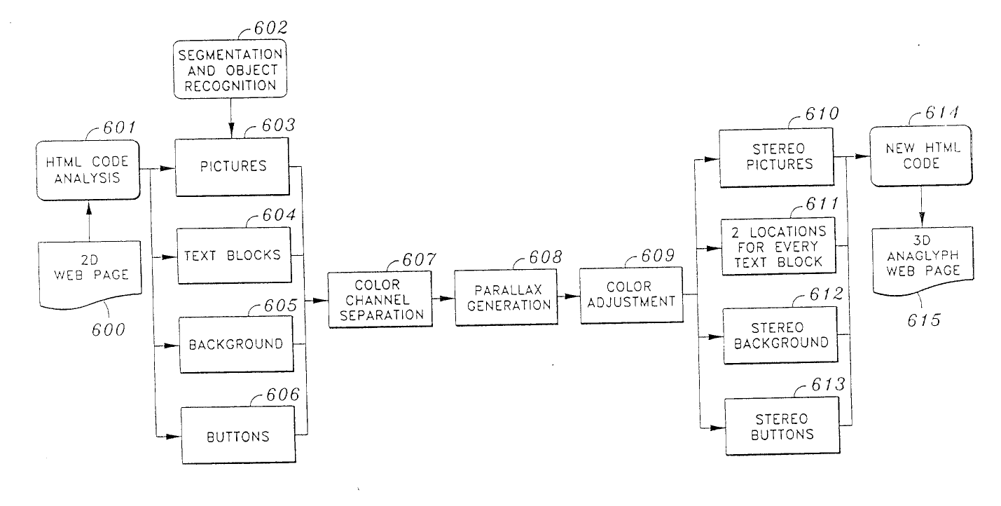

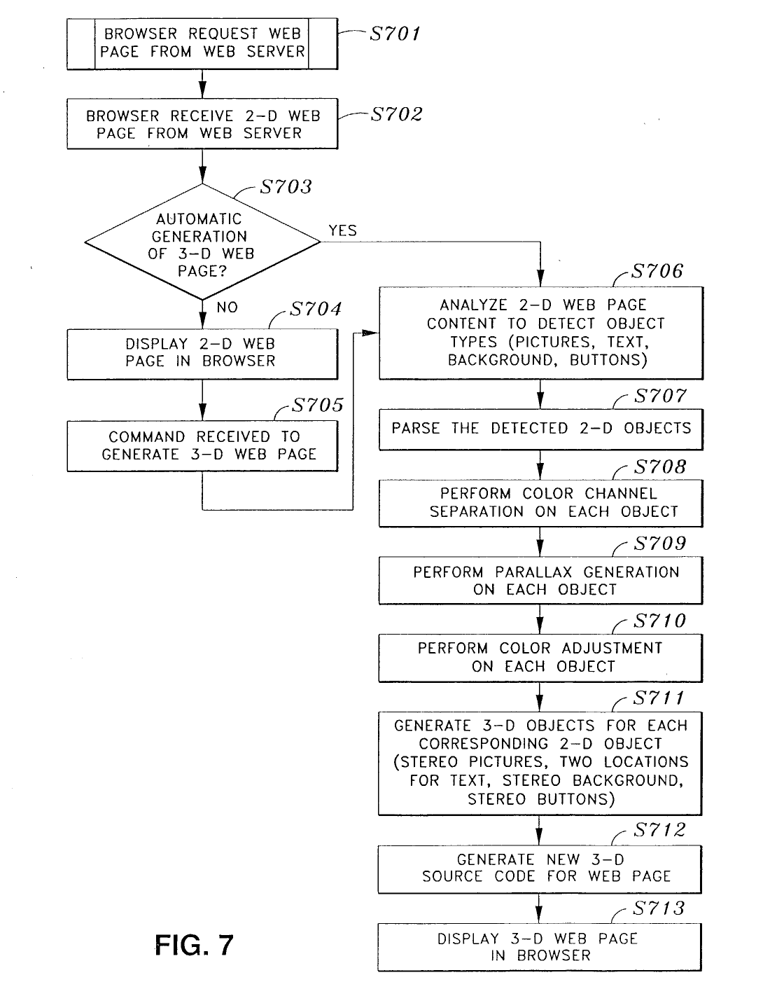

Referring to the process steps of FIG. 7 and the block diagram of FIG. 6, briefly, a two dimensional web page is received by a web browser and if a three dimensional web page is to be generated, the two dimensional web page is analyzed to segment various objects, the objects are processed for color and depth creation (e.g., color channel separation, parallax generation and color adjustment) so as to create new three dimensional objects, and the new objects are assembled into new source code to form a three dimensional web page.

In more detail, a user performs a process in their web browser to download (retrieve) a web page 600 from a web server (step S701). Such a process is well known and could constitute a user inputting a URL of a web page into their web browser. The browser receives the web page (step S702) and the browser determines whether or not automatic generation of a three dimensional web page has been set as a default in the browser (step S703). In this regard, the web browser could be set to automatically create a three dimensional web page from each two dimensional web page downloaded to the browser. Optionally, the browser could be set to merely display the two dimensional web page as a default and would only generate a three dimensional web page if a user selects an option to do so. If automatic generation of a three dimensional web page is not set as the default, the web browser merely interprets the 2-D source code and displays the two dimensional web page (step S704). If, however, automatic generation of a three dimensional web page is set as the default, or if after the two dimensional web page is displayed in the browser, the user selects an option in the web browser to generate a three dimensional web page (step S705), then the three dimensional generation process commences at step S706.

In step S706, the 2-D source code 601 for the web page is analyzed to detect and segment various object types. Such an analysis (602) may consist of automatically detecting attribute tags in the source code including tags for main objects such as background, images (pictures), text and buttons (e.g., hyperlink buttons). It should be noted that, while various types of objects may be included in web page content, the present invention preferably detects the main objects in the web page, although various versions of the present invention could readily be employed to detect other objects as well. The objects (603 to 606) are preferably segmented by a content parser so that a determination can be made which algorithms are to be used for which objects in creating the three dimensional web page. Referring now to the two dimensional source code in FIG. 8 for the web page display of FIG. 4, a tag 400 (<BODY BACKGROUND>) can be seen to correspond to a background attribute “mono jpg”, tags 401 and 404 (<IMG>) correspond to images “hr.jpg” and “rendering2d.jpg”, tag 402 (<FONT>) corresponds to text “Red & Blue Glasses are required to view images in 3D”, and tag 403 (<A>) corresponds to an anchor tag for image “rendering2d.jpg” which has a hypertext reference (HREF), so it can be considered as a button. Thus, four main object types are present in the 2D content of FIG. 8: background, image, text and a hyperlink button. Having detected the main objects, they are parsed so as to be processed further to create the anaglyph web page.

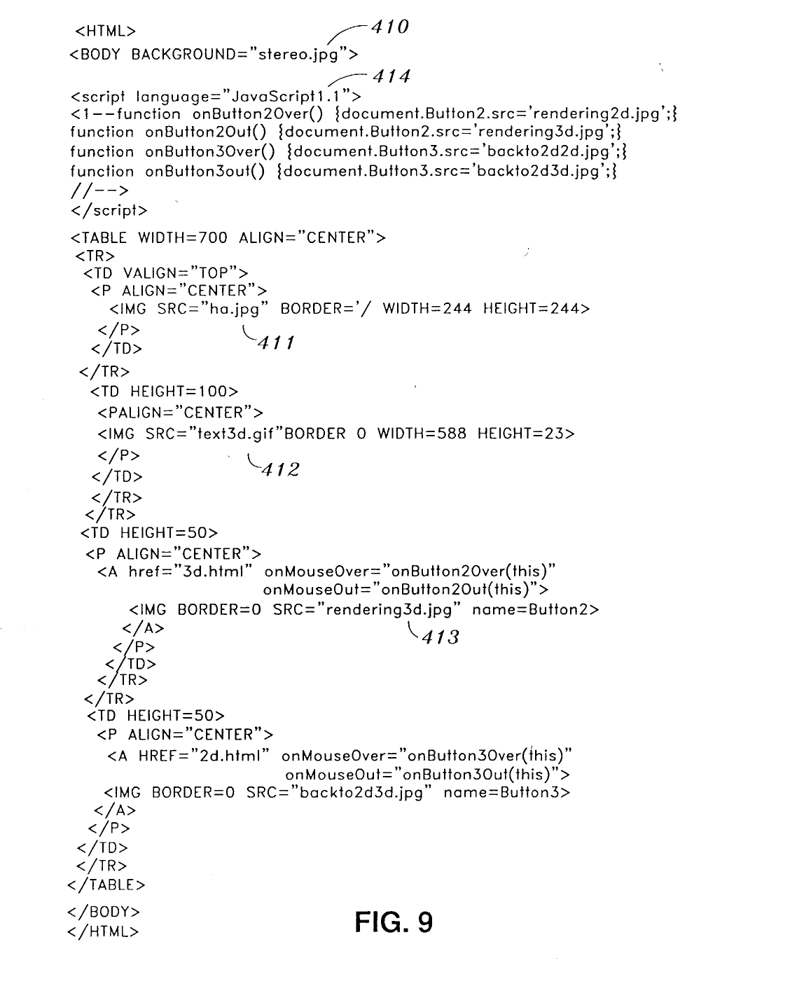

In creating the anaglyph web page of FIG. 5 (and the corresponding HTML code of FIG. 9), the first step is to perform color channel separation (step S708). Color channel separation (607) for anaglyph images shifts the red color channel from the blue and green color channels for viewing with red/blue glasses. After having performed the color channel separation, in step S709, parallax generation (608) is performed to provide depth for each object. Parallax generation creates depth by prescribing different shifts between channels for the objects, which shift may be set in advance for each object type. In this regard, algorithms are run on each object to provide the desired shift so as to place the object at a desired depth relative to the screen. The settings for the depth creation can be some default setting that is set in advance, or could be user defined. For example, the background could be set behind the screen at some depth, text could be set somewhere between the background and the screen, a picture frame could be set at the level of the screen, and buttons could be set in front of the screen. The particular depth map used may depend on the type of viewing device used to view the three dimensional web page. Various enhancements could also be added to the object, such as adding simple JavaScript to increase the 3D effect by moving hyperlink buttons downward when the cursor is moved over the button. Such an enhancement can be seen in the source code of the three dimensional web page of FIG. 9 (JavaScript 414).

Having performed parallax generation, then color adjustment (609) may be performed (step S710), although such a process is not necessarily required. The color adjustment may be performed by first performing a page-wise analysis of the entire page to determine an appropriate color scheme for the final output. Then, an object-wise analysis may be performed on each individual object to determine how best to relate them to the final overall page output. An intra-object color analysis may also be performed to examine an object's colors and determine what changes may be required for optimal viewing of the object. In addition, some objects may be reduced to grayscale for improved perception, and text identification and font color adjustment may be performed for text objects.

Each of the objects, having been subjected to color channel separation, parallax generation and (optionally) color adjustment, are then converted into new three dimensional objects (610 to 613) (step S711). Each of the new three dimensional objects are then assembled into a new HTML (or other web page type) source code (614) (step S712). The three dimensional web page source code that results from the foregoing process is depicted in FIG. 9. Referring to the source code, it can be seen that a new file “text3d.gif” (412) has been created to substitute for the original text. In addition, a new filed “stereo.jpg” (410) has been created and substituted for the background, a file “rendering3d.jpg” (413) has been created as a 3D analog button, and a new file “ha.jpg” (411) has been created as an anaglyph analog of the central image. Additionally, as described above, JavaScript 414 has been added to the source code as an enhancement. As can readily be seen, the structure of the source code remains fairly the same as the original code, except for some substitutions and additions. The new three dimensional source code is then displayed by the browser so the user can view the three dimensional (anaglyph) web page (616) (step S713).

Thus, utilizing the foregoing content parser, an anaglyph image can be created automatically for each two dimensional web page received by a web browser. Accordingly, virtually any web page can be viewed in three dimensions.

While the foregoing description related to the generation of an anaglyph image, the invention is not limited to such and other techniques to generate a three dimensional web page could be used instead. For instance, if stereo gear is used to view three dimensional web pages, then a somewhat different process would be performed in place of the color channel separation, parallax generation and color adjustment processes. In the case of shutter glasses, two separate web pages would be created, one for the left eye and one for the right eye, respectively. The code for each of the new web pages will be almost the same, but the objects will be slightly different (i.e., shifted).

For example, two new files for use in two web pages would be created for the background image: “mono_left.jpg” and “mono_right.jpg”. In the first file, all the pixels would be shifted to the left, and in the second file, all the pixels would be shifted to the right the same distance. The distance may depend on the screen resolution. In contrast, the frame for the central image may remain at the same location for both eyes (i.e., both web pages) because it may be desirable to keep the frame at the level of the screen. Images inside the frame could be converted into 3D using available conversion techniques. Similarly, two new files would be created for buttons, while text may be shifted in opposite directions in the two web pages in order to be placed at a prescribed depth. The two web pages that result are then viewed synchronously by shutter glasses so that the left eye sees only the left web page and the right eye sees only the right web page.

The invention has been described with particular illustrative embodiments. It is to be understood that the invention is not limited to the above-described embodiments and that various changes and modifications may be made by those of ordinary skill in the art without departing from the spirit and scope of the invention.

What is claimed is:

1. A method of automatically generating a three dimensional web page from a two dimensional web page for display in a web browser, the method being performed within the web browser and comprising the steps of:
the web browser receiving two dimensional content for the two dimensional web page;
parsing the two dimensional content to separate objects contained in the two dimensional content and to identify an object type for the objects contained in the two dimensional content;
processing the objects differently, based on the object type identified in the parsing step, to generate three dimensional content for the objects; and
generating the three dimensional web page utilizing the three dimensional content for the objects obtained in the processing step.

2. A method according to claim 1, wherein the parsing step comprises identifying object tags for the objects contained in the two dimensional content.

3. A method according to claim 2, wherein the object tags comprise one of HTML tags, XML tags, and JAVA tags.

4. A method according to claim 1, wherein the method is performed in response to a command input in the web browser to generate a three dimensional display of the two dimensional web page.

5. A method according to claim 1, wherein the method is performed by a plug-in module for the web browser.

6. A method according to claim 1, wherein the objects contained in the web page comprise at least one of text, buttons, frames, images, animations and video.

7. A method according to claim 1, further comprising, between the parsing and processing steps, performing the steps of:
color channel separation to separate different color channels; and
parallax generation to prescribe different shift between channels to different objects so as to create depth.

8. A method according to claim 7, further comprising, after the parallax generation step, performing color adjustment to replace colors with enhanced colors so as to improve depth perception.

9. A method according to claim 7, wherein the different colors separated in the color channel separation step comprise red, blue and green.

10. A method according to claim 7, wherein the method results in generation of anaglyph images.

11. A method according to claim 1, wherein the objects are processed differently in the processing step by applying a different algorithm for each object type identified in the parsing step.

12. A method according to claim 1, wherein the two dimensional content comprises HTML source code for 2D display and wherein the three dimensional content comprises new HTML source code for three dimensional display, the new HTML source code being provided to the web browser for display of the three dimensional web page.

13. A software module for automatically generating a three dimensional web page from a two dimensional web page for display in a web browser, the module comprising computer executable codes for performing the steps of:
parsing two dimensional content, corresponding to a two dimensional web page received by the web browser, to separate objects contained in the two dimensional content and to identify an object type for the objects contained in the two dimensional content;
processing the objects differently, based on the object type identified in the parsing step, to generate three dimensional content for the objects;
generating a three dimensional web page utilizing the three dimensional content for the objects obtained in the processing step; and
providing the three dimensional web page to the web browser for display.

14. A module according to claim 13, wherein the parsing step comprises identifying object tags for the objects contained in the two dimensional content.

15. A module according to claim 14, wherein the object tags comprise one of HTML tags, XML tags, and JAVA tags.

16. A module according to claim 13, wherein the module is performed in response to a command input in the web browser to generate a three dimensional display of the two dimensional web page.

17. A module according to claim 13, wherein the module is a plug-in module for the web browser.

18. A module according to claim 13, wherein the objects contained in the web page comprise at least one of text, buttons, frames, images, animations and video.

19. A module according to claim 13, further comprising, between the parsing and processing steps, performing the steps of:
color channel separation to separate different color channels; and
parallax generation to prescribe different shift between channels to different objects so as to create depth.

20. A module according to claim 19, further comprising, after the parallax generation step, performing color adjustment to replace colors with enhanced colors so as to improve depth perception.

21. A module according to claim 19, wherein the different colors separated in the color channel separation step comprise red, blue and green.

22. A module according to claim 19, wherein the module results in generation of anaglyph images.

23. A module according to claim 13, wherein the objects are processed differently in the processing step by applying a different algorithm for each object type identified in the parsing step.

24. A module according to claim 13, wherein the two dimensional content comprises HTML source code for 2D display and wherein the three dimensional content comprises new HTML source code for three dimensional display, the new HTML source code being provided to the web browser for display of the three dimensional web page.
